(19) United States
(12) Patent Application Publication
(10) Pub. No.: US 2008/0117178 A1
(43) Pub. Date: May 22, 2008

(54) ELECTRONIC DEVICES HAVING A TOUCH SCREEN AND METHOD FOR STARTING THE ELECTRONIC DEVICES

(75) Inventors: CHUNG-YANG KO, Tu-Cheng (TW); CHIN-FENG CHEN, Tu-Cheng (TW); TAY-YANG LIN, Tu-Cheng (TW); YUAN-HUNG CHIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/843,663

(22) Filed: Aug. 23, 2007

(30) Foreign Application Priority Data
Nov. 20, 2006 (CN) 200610201117.1

(51) Int. Cl. G06F 3/041

(52) U.S. Cl. 345/173

(57) ABSTRACT

An exemplary electronic device (10) comprises a display (11), a chip controller (131), a power supply (14) and a main processor (12). The display has a touch screen (111). The power supply is electrically connected to and controlled by the chip controller. The main processor is electrically connected to the chip controller. The main processor is used to store a start operational input and calculate a touched signal that the touch screen is touched. The main processor further compares the touched signal with the start operational input to decide whether to send a start instruction to the chip controller to start the electronic device. The present invention further provides a method for starting the electronic device.

### CROSS-REFERENCE TO RELATED APPLICATIONS

This application is related to four co-pending U.S. patent applications (Attorney Docket No. US11801, US11802, US11803, US11804), all entitled “ELECTRONIC DEVICES HAVING A TOUCH SCREEN AND METHOD FOR STARTING THE ELECTRONIC DEVICES”, by Chung-Yang Ko et al. Such applications have the same assignee as the instant application and are concurrently filed herewith. The disclosure of the above-identified applications is incorporated herein by reference.

### BACKGROUND OF THE INVENTION

1. Field of the Invention

The present invention relates to electronic devices having a touch screen and methods for starting the electronic devices.

2. Discussion of the Related Art

Nowadays, electronic devices are popular and are used in a variety of situations. However, electronic devices also carry certain risks. For example, personal information stored in electronic devices such as mobile phones, personal digital assistants (PDAs) and personal computers may be stolen by others.

One typical electronic device includes an on/off key and a lock/unlock key. Anyone can turn on or unlock the electronic device by pressing the on/off key or the lock/unlock key when the electronic device is turned off or locked. Thus, information stored in the electronic device can be easily accessed and used for malicious purposes. In order to keep information secured, passwords are usually required when turning on or unlocking the electronic device. However, inputting passwords often involves typing several letters and/or numbers on a keyboard, making it very inconvenient to turn on or unlock the electronic device.

Therefore, a need exist for electronic devices that can conveniently be turned on or unlock, to keep information secured, and the methods thereof.

### SUMMARY

An exemplary electronic device includes a display having a touch screen, a chip controller, a power supply and a main processor. The power supply is electrically connected to and controlled by the chip controller. The main processor is electrically connected to the touch screen, and the chip controller. The main processor is used to store a start operational input including at least one of a predetermined touched area, a predetermined touched duration, and a predetermined number of touched times and calculate a touched signal including at least one of touched area, touched duration, and number of touched times that the touch screen touched. The main processor is used to further compare the touched signal with the start operational input to decide whether to send a start instruction to the chip controller to start the electronic device. The touch screen includes a first substrate and a second substrate separated from the first substrate.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present electronic device and method for starting the electronic device, and associated electronic device. Moreover, in the drawings, like reference numerals designate corresponding parts throughout the several views.

FIG. 1 is a schematic view of an electronic device in accordance with an exemplary embodiment of the present invention.

FIG. 2 is a side cross-sectional view of a touch screen of the electronic device of FIG. 1.

FIG. 3 is a view showing a working principle of the touch screen of FIG. 2.

FIG. 4 is a top plan view of the touch screen of FIG. 3 divided by imaginary lines.

FIG. 5 is a flow chart of starting the electronic device of FIG. 1.

### DETAILED DESCRIPTION OF THE EMBODIMENTS

The present invention provides an electronic device such as a mobile phone or a PDA, and a method for starting the electronic device.

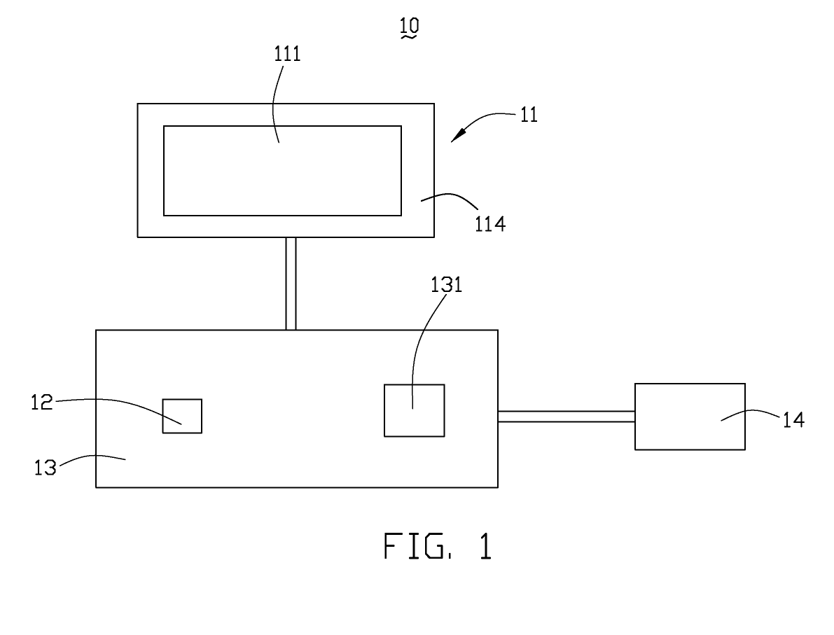

Referring to FIG. 1, an electronic device 10 includes a display 11, a main processor 12, a circuit board 13, and a power supply 14. The display 11 includes a frame 14 and a touch screen 111 confined within the frame 14. The frame 14 and the touch screen 111 are quadrilaterals in shape. A chip controller 131 is mounted on the circuit board 13. The main processor 12 is mounted on the circuit board 13. The display 11 is electrically connected to the main processor 12 via the circuit board 13, and the power supply 14 is electrically connected to the chip controller 131 via the circuit board 13. The chip controller 131 is electrically connected to the main processor 12 via the circuit board 13. Alternatively, the main processor 12 can also be outside the circuit board 13 and directly connected to the display 11 and the power supply 14.

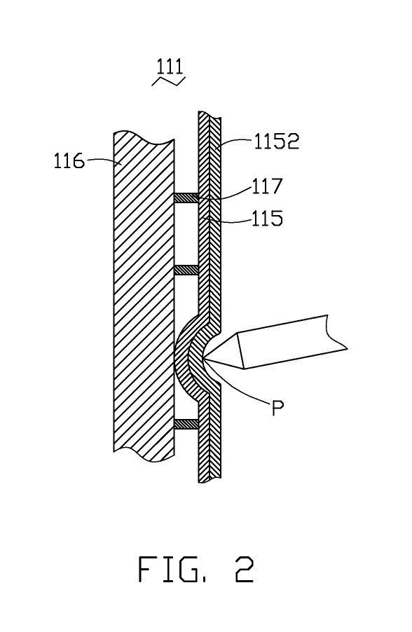

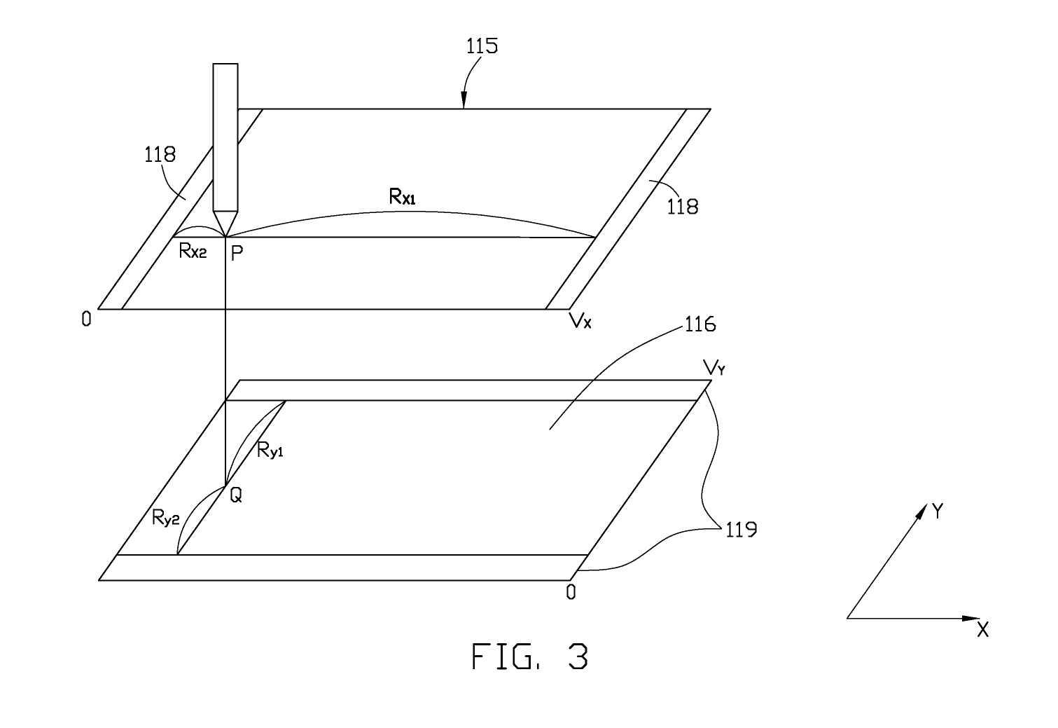

Referring to FIG. 2 and FIG. 3, the touch screen 111 is a resistive touch screen. The touch screen 111 includes a first substrate 115, a second substrate 116 separated from the first substrate 115, and a plurality of transparent insulating spacers 117 disposed between the first substrate 115 and the second substrate 116. The first substrate 115 and the second substrate 116 are transparent and elastic. Each of the first and second substrates 115, 116 has a transparent resistive coating (not shown) coated on a surface thereof, and the transparent resistive coatings of the first and second substrates 115, 116 face each other. The resistive coatings can be indium-tin-oxide (ITO) films. The touch screen 111 can also include a protective coating 1152 for protecting the first substrate 115 of the touch screen 111. In the embodiment, the touch screen 111 is a four-wire-resistive touch screen. Two first electrodes 118 are disposed at two opposite sides of the first substrate 115 correspondingly. The first electrodes 118 are parallel to a Y-axis direction. Two second electrodes 119 are disposed at another two opposite sides of the second substrate 116 correspondingly. The second electrodes 119 are parallel to an X-axis that is perpendicular to the Y-axis direction. The first and second electrodes 118, 119 are connected to the main processor 12. Voltages are applied to the first electrodes 118 and the second electrodes 119 in an alternating manner. Such that, the first electrodes 118 of the first substrate 115 can establish a 0-V_{X} voltage gradient across the resistive coating of the first substrate 115. In the same way, the second electrodes 119 can establish a 0-V_{Y} voltage gradient across the resistive coating of the second substrate 116.

How the four-wire-resistive touch screen 111 works is described hereinafter. When a user touches a point “P” of the touch screen 111 with a finger or a stylus, the resistive coating of the first substrate 115 contacts with the resistive coating of the second substrate 116, and the first substrate 115 of the touch screen 111 forms an electrical circuit with the second substrate 116. A voltage Vpx in the X-axis direction is V_{X}*R_{X2}/(R_{X1}+R_{X2}). The main processor 12 then measures the voltage in the X-axis direction at the point “P” and calculates an X-coordinate of the point “P”. Similarly, a voltage Vpy in the Y-axis direction is V_{Y}*R_{Y2}/(R_{Y1}+R_{Y2}). A Y-coordinate of the point “P” can also be calculated by the main processor 12. Using the method mentioned above, the main processor 12 can calculate the position of the point “P” described by the X-coordinate and the Y-coordinate according to the voltages Vpx, Vpy of the point “P”. A touched duration can also be calculated by the main processor 12 according to how long the voltages Vpx, Vpy exist. A number of touched times (i.e., the touch screen 111 is touched for two times or three times etc.) can also be calculated by the main processor 12 according to how many times the voltages Vpx, Vpy exist. Thereby, the main processor 12 calculates a touched signal including the touched area, the touched duration, and the number of touched times.

In alternative embodiment, the touch screen 111 can be a five-wire system. The five-wire system is similar to the four-wire-resistive touch screen except that in the five-wire system, four electrodes (two pairs) are placed on the second substrate 116. The second substrate 116 has a resistive ITO coating. One pair of electrodes is connected across two opposite sides of the second substrate 116 and the other pair of electrodes is connected across the other two sides of the second substrate 116. The first substrate 115 has a conductive coating and this conductive coating is the fifth electrode which performs as a measuring probe. Two voltages Vx′ and Vy′ are alternately applied to the two pairs of electrodes. Thus, an X-axis voltage gradient and a Y-axis voltage gradient are established across the second substrate 116 alternately. When the touch screen 111 is touched at a point P′, the first substrate 115 and the second substrate 116 electrically connects to each other. The first substrate 115, performing as a measuring probe, measures voltages Vxp′ along the X-axis and Vyp′ along the Y-axis alternately. The probe sends the voltages Vxp′ and Vyp′ to the main processor 12. Similar to the four-wire resistive touch screen described above, the voltages Vxp′ and Vyp′ reflect X and Y coordinates of the point P′ according to the formulas Vxp′=Rx′*Vx″/R″ and Vyp′=Ry′*Vy″/R″ (where R′ stands for a value of resistance of the resistive ITO coating of the second substrate 116, Rx′ stands for a value of resistance from an original point to point P′ along the X-axis, and Ry′ stands for a value of resistance from an original point to point P′ along the Y-axis).

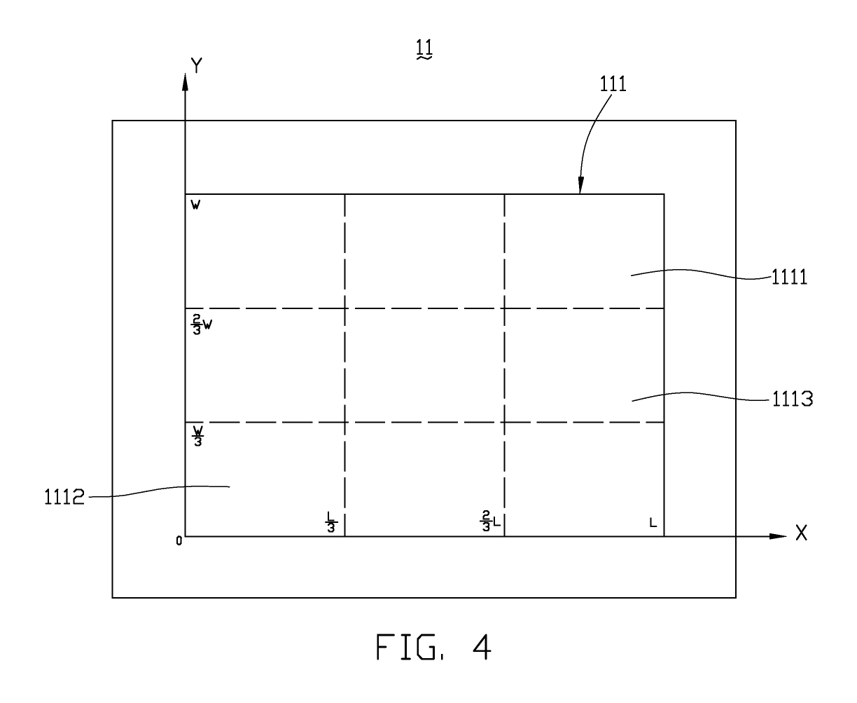

Referring to FIG. 4, the touch screen 111 of the electronic device 10, controlled by the main processor 12, is divided into several areas including areas 1111, 1112, and 1113. The touch screen 111 with a length of “L” in the X-axis direction and a width of “W” in the Y-axis direction is divided into nine areas, each of the nine areas having a width of “L/3” in the X-axis direction and a length of “W/3” in the Y-axis direction. Alternatively, the touch screen 111 can also be divided into any number of areas such as four or more than four areas. For each area, the area is regarded as touched when any point in the area is touched.

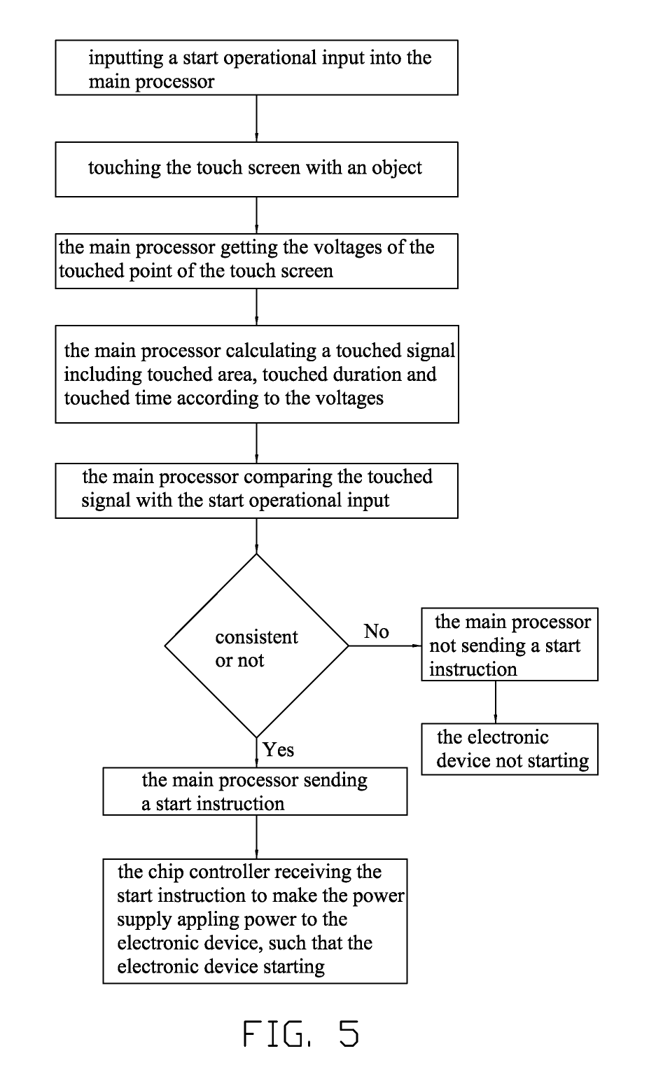

Referring to FIG. 5, a method for starting the electronic device 10 is provided as below:

### (1) A start operational input including a predetermined touched area, a predetermined touched duration, and a predetermined number of touched times is inputted into and stored in the main processor 12;

### (2) An object such as a finger touches the touch screen 111;

### (3) As described above, the main processor 12 gets the voltages of the touched point;

### (4) The main processor 12 calculates a touched signal including the touching areas, the touched duration and the number of touched times according to the voltages; and

(5) The main processor 12 compares the touched signal with the start operational input. If the touched signal is the same as the start operational input, the main processor 12 generates and sends the start instruction to the chip controller 131 of the circuit board 13 to make the power supply 14 applying power to the touch screen 111. Then the electronic device 10 starts (including turn on or unlock). If the touched signal is different from the start operational input, the electronic device 10 does not start.

Referring to FIG. 4 again, for example, the start operational input includes: simultaneously touching areas 1111, 1112 for at least five seconds three times. Only when areas 1111, 1112 are simultaneously touched for at least five seconds three times, the main processor 12 sends the start instruction and the electronic device 10 starts. If areas 1111, 1113 are simultaneously touched for at least five seconds, the main processor 12 calculates touched signal and compares the touched signal with the start operational input. The main processor 12 does not send any start instruction for starting the electronic device 10 because the touched area of the touched signal is not consistent with the predetermined touched area of the start operational input. If areas 1111, 1112 are simultaneously touched for three seconds three times, the main processor 12 does not send any start instruction for starting the electronic device 10 because the touched duration of the touched signal is not consistent with the predetermined touched duration of the start operational input. If areas 1111, 1112 are simultaneously touched for at least five seconds twice, the main processor 12 does not send any start instruction for starting the electronic device 10 because the number of touched times of the touched signal is not consistent with the predetermined number of touched times of the start operational input.

The electronic device can also be started or unlocked by using one or two of the three predetermined touch values. In other words, the start operational input signal may be activated using one or two of the touch values instead of all three. For example, the start operational input includes the predetermined touched area, only. With this condition, no matter how long and how many times the touch screen 111 is touched as long as the touched position is consistent with the touched area of the start operational input, the main processor 12 sends the start instruction for starting the electronic device 10. Thus, only one start operational input is needed to turn on or unlock the electronic device 10. With this condition, the main processor 12 always compares the touched signal with the start operational input to turn on or unlock the electronic device 10. In another example, the start operational input includes two touch values, a predetermined touched area and a predetermined touched duration. With this condition, no matter how many times the touch screen 111 is touched as long as the touched position and the touched duration are consistent with the touched area and the touched duration of the start operational input, the main processor 12 sends the start instruction for starting the electronic device 10. Thus, only two values, of the start operational input, are needed to turn on or unlock the electronic device 10.

Additionally, a start operational input may be used for turning on the electronic device and a different start operational input may be used for unlocking the electronic device. With this condition, the main processor 12 compares the touched signal with one of the start operational inputs regarded as the turning on signal to turn on the electronic device 10 and compares another touched signal with the other start operational input regarded as the unlocking signal to unlock the electronic device 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device comprising:
a display having a resistive touch screen, the touch screen comprising a first substrate and a second substrate separated from the first substrate;
a chip controller;
a power supply electrically connected to and controlled by the chip controller; and
a main processor electrically connected to the touch screen, and the chip controller, the first and second substrates connected to the main processor, the main processor being used to store a start operational input including at least one of a predetermined touched area, a predetermined touched duration, and a predetermined number of touched times and calculate a touched signal including at least one of touched position, touched duration, and number of touched times that the touch screen is touched, the main processor being used to further compare the touched signal with the start operational input to decide whether to send a start instruction to the chip controller to start the electronic device.

2. The electronic device as claimed in claim 1, wherein each of the first and second substrates has a transparent resistive coating coated on a surface thereof, and the resistive coatings face each other.

3. The electronic device as claimed in claim 2, wherein the transparent resistive coatings are indium-tin-oxide films.

4. The electronic device as claimed in claim 1, wherein the first substrate and the second substrate are transparent and elastic.

5. The electronic device as claimed in claim 1, wherein the touch screen further comprises a plurality of transparent insulating spacers disposed between the first substrate and the second substrate.

6. The electronic device as claimed in claim 1, wherein the touch screen further comprises a protective coating located on the first substrate for protecting the first substrate of the touch screen.

7. The electronic device as claimed in claim 1, wherein the display further comprises a frame for confining the touch screen.

8. The electronic device as claimed in claim 7, wherein the frame and the touch screen are quadrilateral in shape, two first electrodes are disposed at two opposite sides of the first substrate respectively, two second electrodes are disposed at two opposite sides of the second substrate, the first and second electrodes are connected to the main processor.

9. The electronic device as claimed in claim 1, wherein the touch screen comprises several areas divided by the main processor.

10. The electronic device as claimed in claim 1 further comprising a circuit board, the main processor and the chip controller are electrically connected with the circuit board.

11. The electronic device as claimed in claim 1 further comprising a circuit board, the chip controller is electrically connected with the circuit board, and the main processor is positioned inside the display.

12. A method for starting an electronic device comprising:
providing an electronic device comprising a display, a chip controller, a power supply and a main processor, the power supply electrically connected with and controlled by the chip controller, the main processor electrically connected with the chip controller, the display having a touch screen, the touch screen comprising a first substrate and a second substrate separated from the first substrate, a voltage applied on the at least one of the first and second substrates;
inputting a start operational input including at least one of a predetermined touched area, a predetermined touched duration and a predetermined number of touched times into the main processor;
touching the touch screen;
the main processor getting voltages of the at least one of the first and second substrates if the touch screen is being touched;
the main processor deducing a touched signal including touching areas, touched duration and number of touched times according to the voltages, and the main processor comparing the touched signal with the start operational input;
the main processor sending a start instruction to the chip controller and the chip controller making the power supply applying power to start the electronic device if the touched signal being consistent with the start operational input.

13. The method as claimed in claim 12, wherein each of the first and second substrates has a transparent resistive coating coated on a surface thereof, and the resistive coatings face each other.

14. The method as claimed in claim 13, wherein the resistive coatings are indium-tin-oxide films.

15. The method as claimed in claim 12, wherein the first substrate and the second substrate are transparent and elastic, the touch screen further comprises a plurality of transparent insulating spacers disposed between the first substrate and the second substrate and a protective coating located on the first substrate for protecting the first substrate of the touch screen.

16. The method as claimed in claim 12, wherein the display further comprises a frame for confining the touch screen.

17. The method as claimed in claim 16, wherein the frame and the touch screen are quadrilateral in shape, two first electrodes are disposed at two opposite sides of the first substrate respectively, two second electrodes are disposed at two opposite sides of the second substrate, the first and second electrodes are connected to the main processor.

18. The method as claimed in claim 17, wherein voltages are acted on the electrodes and the electrodes alternately, the first electrodes of the first substrate establish a voltage gradient across the resistive coating of the first substrate and the second electrodes establish a voltage gradient across the resistive coating of the second substrate.

19. The method as claimed in claim 18, wherein when a user touches the touch screen, the resistive coating of the first substrate contacts with the resistive coating of the second substrate, and the first substrate of the touch screen forms an electrical circuit with the second substrate, the main processor measures the voltage in the an X-axis direction and a Y-axis direction, and calculates a coordinate of the touched point.
